(19) United States
(12) Patent Application Publication
(10) Pub. No.: US 2022/0280960 A1
(43) Pub. Date: Sep. 8, 2022

(54) Solution Dispensing Device

(71) Applicant: Robert Wise, Penngrove, CA (US)

(72) Inventor: Robert Wise, Penngrove, CA (US)

(21) Appl. No.: 17/825,236

(22) Filed: May 26, 2022

Related U.S. Application Data
(63) Continuation of application No. 17/318,220, filed on May 12, 2021.
Application No. 17/318,220 is a continuation-in-part of application No. 17/223,156, filed on Apr. 6, 2021.
Application No. 17/223,156 is a continuation-in-part of application No. 17/018,691, filed on Sep. 11, 2020, now Pat. No. 11,253,882.

(51) Int. Cl. B05B 11/00

(52) U.S. Cl. CPC B05B 11/0081; B05B 11/0062; B05B 11/3038; B05B 11/0054; B05B 11/3057; B05B 11/0097

(57) ABSTRACT

A solution dispensing device includes a housing having an upper section and a lower section that seal when coupled, and an interior volume that functions as a refillable reservoir, the interior volume reservoir accessible via an aperture, whereby a refill cartridge containing a solute solution is deposited within the interior volume reservoir via an aperture, the solute solution and refill cartridge housing dissolving within varied measure of prescribed solvent added within the interior volume of the lower section reservoir. An actuator mechanism is configured to cause the mixed concentrate solution, which includes a combination of a dissolved solute solution, a dissolved refill cartridge, and a solvent, deposited within the refillable solution reservoir, to be drawn through and held within the actuator mechanism of the device, readied to be dispensed via an external port of the device, upon activation of the mechanism of the actuator external of the device housing.

### CROSS REFERENCE TO RELATED APPLICATIONS

The present application is a continuation of U.S. patent application Ser. No. 17/375,430, filed on Jul. 14, 2021, which claims the benefit of U.S. patent application Ser. No. 17/318,220 filed on May 12, 2021, which claims the benefit of U.S. patent application Ser. No. 17/223,156 filed on Apr. 6, 2021, which claims the benefit of U.S. patent application Ser. No. 17/018,691 filed on Sep. 11, 2020. The above identified patent applications are incorporated by reference in their entirety to provide continuity of disclosure.

### BACKGROUND

The present invention relates to solution dispensing devices. More particularly, the present invention provides a refillable solution dispensing device.

Currently, many solution dispensers that produce a solution are placed into a can and dispensed with an aerosol product. These cans produce a large amount of waste. This waste is deposited in landfills to eventual one day break down. Even after the cans break down, the residual, potentially harmful interior material is then released into the soil or air. This can cause further damage to an area of land.

Traditional aerosol cans use dangerous gases to pressurize the cans. In some instances, these gases are only harmful to the overall environment. In other instances, these gases are poisonous to humans. These gases may cause damage to a body or even cause cancer. These gases may even be deadly if inhaled. The combination of gases and having sealed metal cans means that refilling these items is not an option.

Many times, solutions in these cans tend to separate over time. This means that the solutions to be ed often change in consistency over time and become weaker. Many times, the instructions are to shake before use. This attempts to mix the solution to reduce the separation effects. This shaking is often unsuccessful and does not properly mix the solution.

Consequently, there is a need for an improvement in the art of solution dispensers. The present invention substantially diverges in design elements from the known art while at the same time solves many environmental issues with current dispensers. In this regard the present invention substantially fulfills these needs.

### SUMMARY OF THE INVENTION

The present invention provides a solution dispensing device wherein the same can be utilized for providing convenience for the user when using a solution dispensing device. The solution dispensing device is comprised of a housing having an upper section and a lower section. The upper section is comprised of a push button exposed on the exterior of the upper section and is connected to an actuator body on the interior of the upper section. The actuator body is movably connected to at least a first air chamber and a at least one solution chamber. The at least one solution chamber is in fluid communication with the solution reservoir at one end and a discharge nozzle at another end. The first air chamber is fluidly connected to the discharge nozzle. The actuator body includes an elongated mixing rod that protrudes into the lower section. The lower section comprises and interior volume that functions as a solution reservoir. A solution mixer is rotatably coupled to the elongated mixing rod.

Another object of the solution dispensing device is to have a second air chamber affixed to the actuator body. The second air chamber is in fluid communication with the discharge nozzle.

Another object of the solution dispensing device is to have a protruding cylinder secured to the bottom of the actuator body. The protruding cylinder protrudes into the lower section.

Another object of the solution dispensing device is to have an output selector which extends through the upper section and is operably coupled to the at least one solution chamber. The output selector controls the amount of solution which exits the device on each.

Another object of the solution dispensing device is to have a first pressure adjustment knob secured to a lower side of the first air chamber. The first pressure adjustment knob controls the pressure of the first air chamber.

Another object of the solution dispensing device is to have a second pressure adjustment knob secured to a lower side of the second air chamber. The second pressure adjustment knob controls the pressure of the second air chamber.

Another object of the solution dispensing device is to have the upper section and the lower section which are removably secured together.

Another object of the solution dispensing device is to have an actuator body which further comprises a spring. The spring will return the actuator body to an extended position after a press of the push button.

Another object of the solution dispensing device is to have a protruding cylinder which houses the elongated mixing rod and the mixing device.

Another object of the solution dispensing device is to have an elongated mixing rod which is connected to the mixing device via threads. The threads cause the mixing device to rotate upon a press from the push button.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the solution dispensing device.

FIG. 2 shows a partially exploded view of an embodiment of the solution dispensing device.

FIG. 3 shows a cross-sectional view of an embodiment of the solution dispensing device.

FIG. 4 shows a cross-sectional view of an embodiment of the solution dispensing device.

FIG. 5 shows a perspective view of an embodiment of the solution dispensing device.

### DETAILED DESCRIPTION OF THE INVENTION

Reference is made herein to the attached drawings. Like reference numerals are used throughout the drawings to depict like or similar elements of the solution dispensing device. For the purposes of presenting a brief and clear description of the present invention, a preferred embodiment will be discussed as used for the solution dispensing device. The figures are intended for representative purposes only and should not be considered to be limiting in any respect.

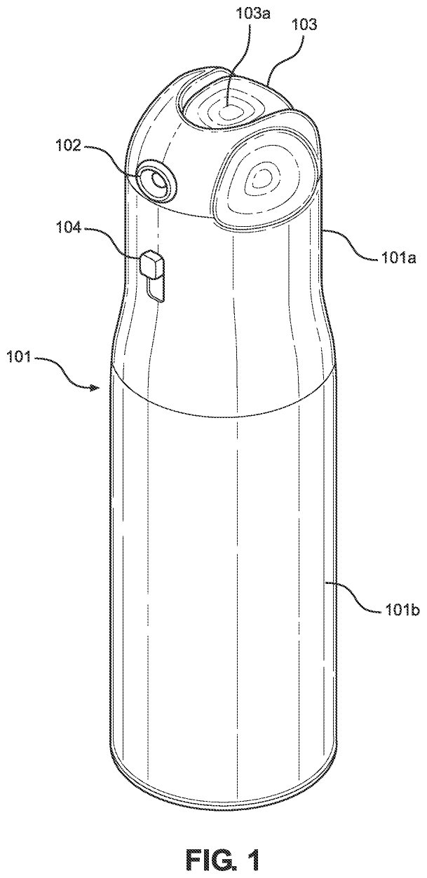

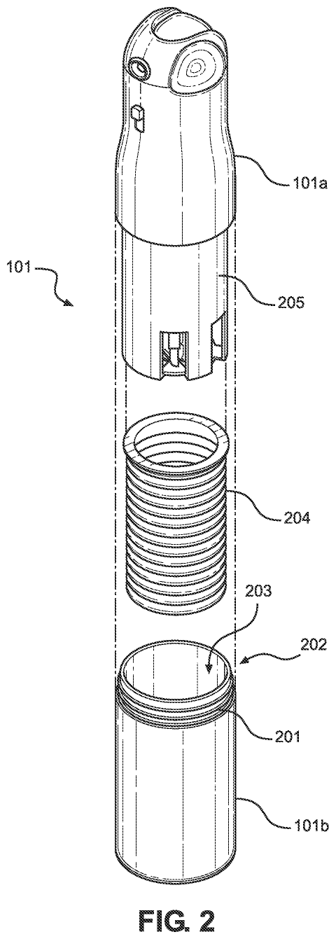

Referring now to FIG. 1, there is shown a perspective view of an embodiment of the solution dispensing device. The solution dispensing device is comprised of a housing 101 having an upper section 101a and a lower section 101b. The upper section 101a and the lower section 101b are secured together as will be described in the description of FIG. 2. In one embodiment, the housing 101 is a cylindrical housing. This will allow the device to be easily held in one hand. While other shapes are plausible as part of this disclosure, a cylinder is the most common for these articles. In one embodiment, the housing 101 narrows toward a top end of the housing. This will allow for the lower section 101b to be larger than the top section 101a. The bigger lower section 101b allows for additional solution to be placed into the dispenser.

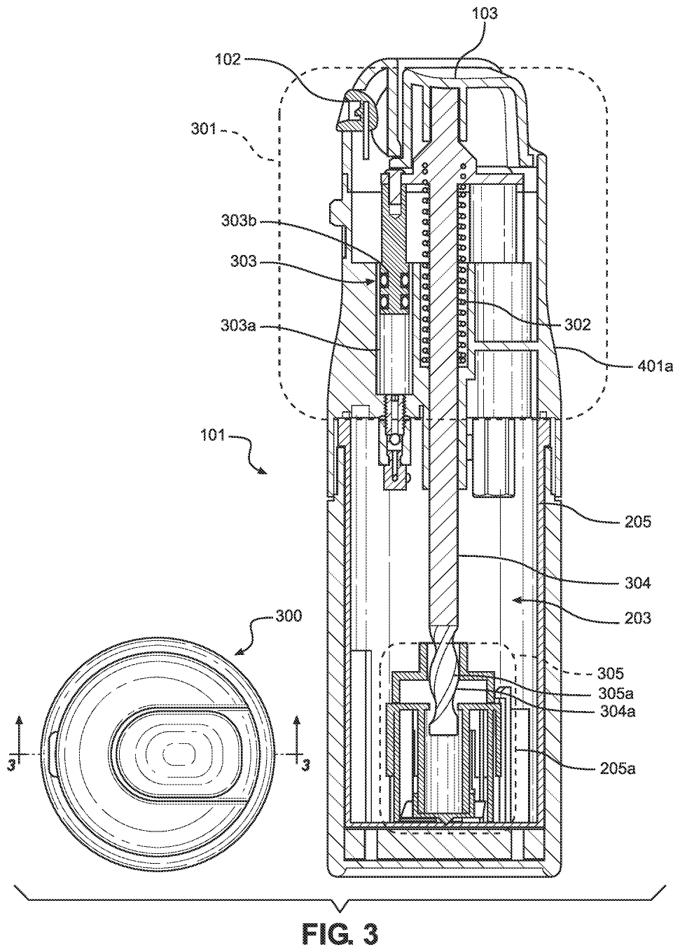

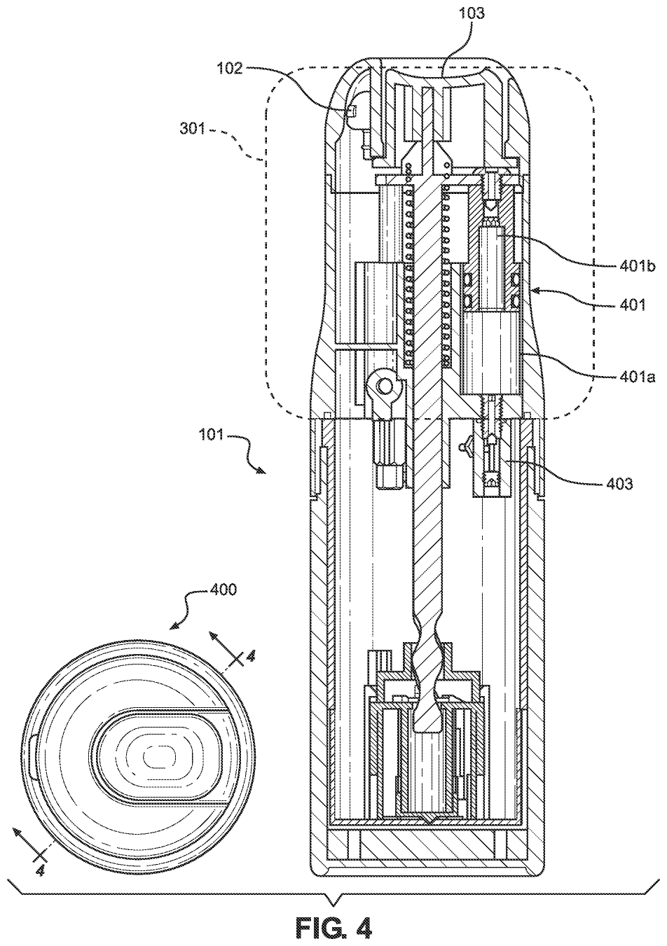

The upper section 101a includes a discharge nozzle 102 in fluid communication with the interior of the dispenser. The connections of the discharge nozzle 102 will be described in the description of FIG. 3 and FIG. 4. The discharge nozzle 102 will allow for the contents of the solution dispenser to be expelled from the device. In one embodiment, the discharge nozzle 102 has an adjustable output. In one embodiment, the discharge nozzle 102 will produce a stream flow. In another embodiment, the discharge nozzle 102 will produce a planar spay. In yet another embodiment, the discharge nozzle 102 will produce a cloud spray. In another embodiment, the discharge nozzle 102 will produce a steam of liquid.

In a further embodiment, the housing 101 has a push button 103 located on a top of the upper portion 101a. The push button 103 movably attached to an actuator housing as described in FIG. 3 and FIG. 4. The push button 103 is movable such that it enters the housing 101 when pushed toward the housing 101. In one embodiment, the push button 103 has a depression 103a thereon. This will allow a finger to be placed in the depression 103a and to remain fixed in position without sliding from the push button 103.

In one embodiment, the exterior of the housing 101 includes a solution volume adjuster 104. The solution volume adjuster 104 will control the amount of solution that is dispensed with each press of the push button 103. The solution volume adjuster 104 will be in contact with the dispensing devices as described in FIG. 3 and FIG. 4. In one embodiment, the solution volume adjuster 104 is a sliding knob that protrudes from the housing 101. In a further embodiment, the solution volume adjuster 104 is located through a channel 105 of the housing 101. In one embodiment, there are indicia located on the housing 101 adjacent to the solution volume adjuster 104, which will correspond to the amount of solution dispensed when the solution volume adjuster 104 is in a specific location.

Referring now to FIG. 2, there is shown a partially exploded view of an embodiment of the solution dispensing device. In this view, the upper section 101a of the housing 101 and the lower section 101b of the housing 101 are separated. In this embodiment, a threading 201 is shown about an upper edge 202 of the lower section 101b. The interior of the upper section 101a has a corresponding threading. This will allow the upper section 101a to be threaded onto the lower section 101b. In another embodiment, the upper section 101a and the lower section 101b have a snap connection.

The lower section 101b has an interior volume. In one embodiment, this interior volume functions as a solution reservoir 203. In another embodiment, there is an additional item located within the lower section which functions as a solution reservoir. The solution reservoir 203 will hold a liquid solution.

In one embodiment, the solution is poured directly into the solution reservoir 203. In another embodiment, a cartridge 204 is placed within the solution reservoir 203. In one embodiment, the cartridge 204 will hold the solution and the solution will be ed from the cartridge 204. In one embodiment, the cartridge 204 is made from plastic. In another embodiment, the cartridge 204 is made from polyvinyl alcohol. In general, the solution cartridge can be made of a flexile material at least from a list of Poly Vinyl Succinate, Poly Vinyl Alcohol, Butene Diol Alcohol Co-Polymer, plastic, organic matter or combination thereof so to release solution concentrate within when compressing the solution cartridge inside the container. Further, the solute solution can be encased in at least a Poly Vinyl Alcohol, Butene Diol Alcohol Co-Polymer cartridge, organic matter, inserted into the solution chamber, to be mixed-together with water added in the solution reservoir dissolving the cartridge and blending the solutions together. There may also be a barrier coated biodegradable enclosure comprising from at least Butene Vinyl Succinate or Butene Diol Vinyl Alcohol Co-Polymer or Poly Vinyl Alcohol or Organic Matter or a composite thereof. The solution cartridge contains varied solute base concentrations of solutions of at least the list of ethanol, bleach, alcohol, water, or a powdered form, and preferably consists of a water dissolving material selected from at least the list of Poly Vinyl Alcohol, Butene Diol Vinyl Alcohol Co-Polymer, Organic matter or composite thereof.

In another embodiment, the upper section 101a includes a protrusion 205. In one embodiment, the protrusion 205 is a cylindrical protrusion. The protrusion 205 will fit within the lower section 101b when the upper housing 101a is secured thereto. In one embodiment, the protrusion 205 will crush the cartridge, thereby expelling the solution into the solution reservoir 203. In one embodiment, the cartridge 204 comprises a plurality of pleats therein, defining an accordion shape. This will allow for the cartridge 204 to properly collapse to dispense the solution.

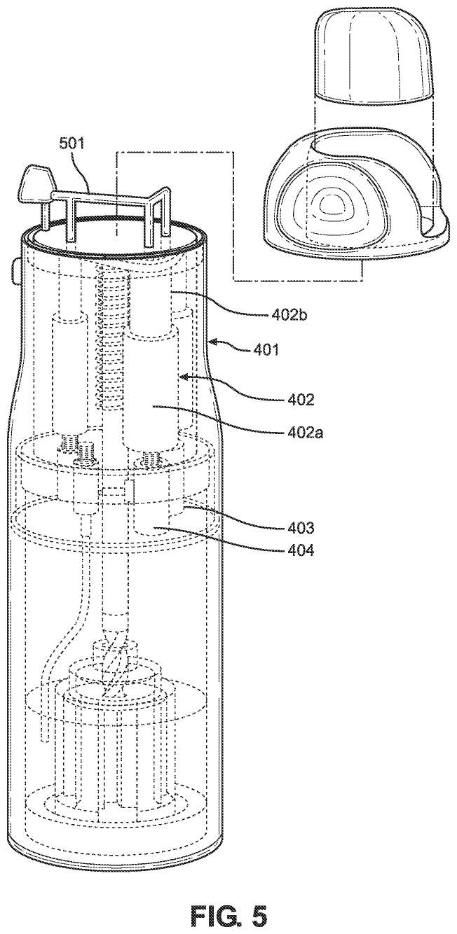

Referring now to FIG. 3, there is shown a cross-sectional view of an embodiment of the solution dispensing device. Please also see FIG. 5 in coordination with FIG. 3. The solution dispensing device includes an actuator body 301. The actuator body 301 is coupled to the push button 103. When the push button 103 is depressed the actuator body 301 is moved along with the push button 103. In one embodiment, at least one spring 302 is included as part of the actuator body 301. The at least one spring 302 will bias the actuator body 301 toward the top of the device. This will allow the push button 103 and the actuator body 301 to reset to an extended position after pressed into a retracted position.

The solution dispensing device includes a at least one solution chamber 303. The at least one solution chamber 303 is comprised of a solution housing 303a and a piston 303b. The at least one solution chamber 303 is secured to the actuator body 301 at one end and the housing 101 at another end. This will allow the piston 303b to be depressed and reset along with the actuator body 301. The at least one solution chamber 303 is in fluid communication with the discharge nozzle 102. This is represented by hose 501 in FIG. 5. One of ordinary skill in the art will recognize that the hose is flexible and will not impede the movement of the push button 103. When the piston 303a is depressed, the solution exits the at least one solution chamber 303 and is ed form the discharge nozzle 102. The at least one solution chamber 303 is further in fluid communication with the solution reservoir 203. When the piston 303b is extended out of the solution housing 303a, the solution housing 303a fills with solution. There is a one way valve that will prevent the solution for re-entering the solution reservoir 203 when the piston 303b is depressed. In one embodiment the piston 303a creates a seal with the solution housing 303b. This will create the suction needed to draw solution from the solution reservoir 203 into the solution housing 303b.

The at least one solution chamber 303 includes a one way valve secured to the solution housing 303a. The one way valve will allow solution to be sucked into the solution housing 303a from the solution reservoir 203. The one way valve will further prevent solution from being dispelled back into the solution reservoir 203. The at least one solution chamber 303 will further include a pressure valve. The pressure valve will open once the solution reaches a predetermined pressure within the solution housing 303a, releasing the solution to the discharge nozzle 102.

In one embodiment, the actuator body or mechanism 301 includes an elongated mixing rod 304. The elongated mixing rod 304 moves with the actuator body 301. The elongated mixing rod 304 is of a length that allows it to enter the lower section 101b of the housing 101 when the upper section 101a and the lower section 101b are secured together. In one embodiment, the elongated mixing rod 304 serves to hold the at least one spring 302 in place and allows it to properly push the actuator body 301 toward the top of the housing 101. In different embodiments the spring is not located around the mixing rod 304. For example, in one embodiment the is a plurality of springs 302 located around the interior perimeter of the push button 102. The elongated mixing rod 304 is further secured to a mixing device 305. In one embodiment, the mixing device 305 is secured to an end of the elongated mixing rod 304. The mixing device 305 will mix the solution within the solution reservoir 203. The actuator mechanism can be engaged into additional chambers to increase solution volume or air volumes or both dispensed through varied discharge nozzle configurations.

In one embodiment, the elongated mixing rod 304 is movably secured to the mixing device 305. In one embodiment, the elongated mixing rod 304 has a threaded end 304a. The mixing device 305 has a corresponding threading 305a. When the elongated mixing rod 304 enters the mixing device 305 as the push button 103 is depressed, the mixing device 305 will spin. In one embodiment, the threaded end 304a of the elongated mixing rod 304 and the corresponding threading 305a of the mixing device 305 will disengage when the actuator body 301 is in the extended position. This will allow the mixing device 305 to continue spinning after each depression of the push button 103.

In one embodiment, the elongated mixing rod 304 is extended into the protrusion 205 of the upper section 101a. Further, in one embodiment, the mixing device 305 is rotatably secured within the protrusion 205. In another embodiment, the protrusion 205 includes a housing 205a which will secure the mixing device. This will ensure that the mixing device 305 will stay at a lower section of the solution reservoir 203 to adequately mix the solution.

The activation of the mixing device 305 on the depression of the actuator body 301 will have additional benefits. The solution enters the at least one solution chamber 303 when the actuator body 301 is extended. This means that already mixed solution will enter the at least one solution chamber 303. This ensures that each time solution is dispensed the is an evenly mixed solution. This further ensures that the solution does not dilute throughout the use of the dispenser.

In one embodiment the dispensing device includes additional solution chambers. The additional solution chambers are configured similar to the at least one solution chamber described above. Each additional chamber will be fluidly connected to a solution reservoir and the discharge nozzle 102. Further, each additional solution chamber will be connected to the push button 103 and the housing 101. In one embodiment the additional solution chambers are of different volumes. This will allow for different solutions to be mixed together creating one discharge. In another embodiment the solution chambers are connected to separate solution reservoirs. This will allow for different mixtures to be created.

Referring now to FIG. 4, there is shown a cross-sectional view of an embodiment of the solution dispensing device. Please also see FIG. 5 in coordination with FIG. 4. The solution dispensing device includes a first air chamber 401. The first air chamber 401 is comprised of an air housing 401a and a piston 401b. The first air chamber 401 is secured to the actuator body 301 at one end and the housing 101 at another end. This will allow the piston 401b to be depressed and reset along with the actuator body 301. The first air chamber 401 is in fluid communication with the discharge nozzle 102. This is represented by hose 501 in FIG. 5. One of ordinary skill in the art will recognize that the hose is flexible and will not impede the movement of the push button 103. When the piston 401a is depressed the air is forced from the air chamber 401 and is ed form the discharge nozzle 102. When the piston 401b is extended out of the first air chamber 401, the first air housing 401a fills with air. There is a one way valve that will prevent the air from exiting the piston the way it came in when the piston 401b is depressed.

The air housing 401a of the first air chamber 401 has an air volume adjuster 403 secured thereto. This will allow for the volume of the air housing 401b to be increased or decreased. This will determine the pressure at which the solution will be ed from the device. In one embodiment, the air volume adjuster 403 is a turn knob which will rise and lower the base of the air housing 401b.

In some embodiments the first air chamber 401 includes a one way valve secured to the air housing 401a. The one way valve will allow air to be sucked into the air housing 401a. The one way valve will further prevent air from being dispelled through the same valve. In another embodiment the air housing 401a will further include a pressure valve. The pressure valve will open once the air within the air housing 401a reaches a predetermined pressure, releasing the air to the discharge nozzle 102.

In a further embodiment, seen specifically in FIG. 5, the solution dispensing device includes a second air chamber 402. The second air chamber 402 is comprised of an air housing 402a and a piston 402b. The second air chamber 402 is secured to the actuator body 301 at one end and the housing 101 at another end. This will allow the piston 402b to be depressed and reset along with the actuator body 301. the second air chamber 402 is in fluid communication with the discharge nozzle 102. This is represented by hose 501 in FIG. 5. One of ordinary skill in the art will recognize that the hose is flexible and will not impede the movement of the push button 103. When the piston 402a is depressed the air is forced from the air chamber 402 and air is ed form the discharge nozzle 102. When the piston 402b is extended out of the second air chamber 402, the second air housing 402a fills with air. There is a one way valve that will prevent the air from exiting the air chamber 402 the way it came in when the piston 402b is depressed.

The air housing 402a of the second air chamber 402 has an air volume adjuster 404 secured thereto. This will allow for the volume of the air housing 402b to be increased or decreased. This will determine the pressure at which the solution will be ed from the device. In one embodiment the air volume adjuster 404 is a turn knob which will rise and lower the base of the air housing 402a.

In some embodiments the first second chamber 402 includes a one way valve secured to the air housing 402a. The one way valve will allow air to be sucked into the air housing 402a. The one way valve will further prevent air from being dispelled through the same valve. In another embodiment the air chamber 402a will further include a pressure valve. The pressure valve will open once the air within the air chamber 402a reaches a predetermined pressure, releasing the air to the discharge nozzle 102.

In this embodiment, the first air chamber 401 and the second air chamber 402 work together. In one embodiment, this will allow the solution to be ed from the dispenser with a greater pressure. In another embodiment, this will allow for less stress to be put on each air chamber 401, 402. In yet a further embodiment, the dual air chambers 401, 402 will allow for redundancy. This means that even if one were to fail, the other could take its place. This would allow the dispenser to still function even if an air chamber becomes damaged.

When the push button 103 is depressed air and varying solutions are mixed together in the fluid connects between the respective chambers and the discharge nozzle, as represented by 501. This will allow for the solution to be dispensed in a number of different ways. Further, in some embodiments this will allow for different solutions to be mixed before exiting the discharge nozzle 102.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A solution dispensing device, comprising:
a housing having an upper section and a lower section that seal when coupled, the lower section comprising an interior volume that functions as a refillable reservoir, the interior volume reservoir accessible via an aperture,
whereby a refill cartridge containing a solute solution is deposited within the interior volume reservoir via an aperture, the solute solution and refill cartridge housing mixing within varied measure of prescribed solvent added within the interior volume of the lower section reservoir;
an actuator mechanism configured to cause the mix of concentrate solution, which includes a combination of a dissolved solute solution, a dissolved refill cartridge, and a solvent, deposited within the refillable solution reservoir, to be drawn through and held within the actuator mechanism of the device, readied to be dispensed via an external port of the device, upon activation of the mechanism of the actuator external of the device housing;
wherein the refill cartridge dissolves including the solute solution within, mix with the measure of prescribed solvent deposited within the refillable solution reservoir, sum combined concentrate solution within the dispenser reservoir refilling the dispenser device more than once, making the solution dispensing device reusable.

2. The solution dispensing device of claim 1, wherein a housing of the refill cartridge includes any one or more of: polyvinyl alcohol, G Polymer, Butyl Diol Vinyl Co Polymer, or a non-toxic water dissolving material.

3. The solution dispensing device of claim 1, wherein the combined concentrate solution is drawn via at least a shaft, a tube, or a portal, which causes a mixing effect while transporting the mixed concentrate solution from a refillable solution reservoir of the lower section into at least a dispensing chamber within the actuator mechanism within the housing of the device.

4. The solution dispensing device of claim 3, whereby the shaft enables a mechanism configured to rotatably move a mixing device within the interior volume reservoir, upon each actuation of the actuator mechanism.

5. The solution dispensing device of claim 1, whereby the solute solution within the refill cartridge is a prescribed quantity to be mixed with a prescribed quantity of solvent added to the refillable solution reservoir thus making the desired mixed concentrate solution.

6. The solution dispensing device of claim 2, whereby the refill cartridge containing the solute solution, dissolves mixing with the solute solution into the solvent added within the refillable solution reservoir combining into the mixed concentrate solution, whereby the dissolved cartridge is dispensed away within the mixed concentrate solution upon activation of the actuator mechanism via the external port of the housing.

7. The solution dispensing device of claim 6, whereby the refill cartridge is biodegradable, nontoxic, organic, or a combination thereof.

8. The solution dispensing device of claim 2, wherein the refill cartridge includes at least one of:
an organic matter, a cellulose, a bonded cellulose, Bio-BPS, or other compostable material, or a combination thereof.

9. The solution dispensing device of claim 2, wherein the refill cartridge includes an amount of solute solution which is deposited within the refillable solution reservoir of the solution dispenser device, wherein the refill cartridge dissolves into a prescribed quantity of solvent is added, releasing and combining the solute solution, the refill cartridge and solvent into the desired mixed concentrate solution.

10. A solution dispensing device comprising:
a lower section of the housing of the solution dispensing device, the lower section having an interior volume used as a refillable solution reservoir, the lower section reservoir having an aperture to access the refillable solution reservoir, the lower section removably coupled to an upper section such that a seal is formed when the lower section and upper section are coupled;
the lower section reservoir including an aperture so to add a varied measure of solvent, deposit a solution cartridge refill with a measured amount of solute solution, about the aperture of the lower section to combine with the solute solution within the cartridge to create a mixed concentrate solution, the mixed concentrate solution drawn from within the refillable solution reservoir fluidly connected to a chamber or chambers within the device draws and causes the mix of solutions to be dispensed via actuation of the actuator mechanism of the device and dispense via an external port of the device;
the refill solution cartridge with solute solution and solvent added to the device lower section reservoir cause the solution dispenser device to be repeatedly refillable and reused.

11. The solution dispensing device of claim 10, wherein an upper section of the housing is coupled and sealed to the lower section upon refill, combining solute solutions as a prescribed portion thereof transfers from the reservoir through the aperture into at least one dispensing chamber within the device, causing the mix of solutions to dispense upon actuation of the actuator mechanism via the external dispense port of the device.

12. The solution dispensing device of claim 10, wherein actuation of the actuator mechanism external to the housing, causes the solvent within the refillable solution reservoir to be drawn into at least one chamber via a shaft, a tube, or a portal, combining with a prescribed measure of the solute solution within the cartridge deposited about the aperture of the lower section, into the chamber or chambers to be dispensed via actuation of the actuator mechanism via the external dispense port of the solution dispensing device.

13. The solution dispensing device of claim 10, wherein the external dispense port is adjustable so to dispense solution within the device with varied patterns and pressures.

14. The solution dispensing device of claim 10, wherein the external actuator mechanism includes a trigger, button, or other mechanism for activating the dispensing of the solution within.

15. The solution dispensing device of claim 10, wherein the refill cartridge includes a material or combination of materials made of at least a biodegradable, nontoxic, organic, or compostable material.

16. The solution dispensing device of claim 10, wherein the refill cartridge is made of a material that can contain a solvent combined with a mixture of ingredients in a solute solution, the cartridge dissolving and combining with the solute solution into an aqueous substance refilling the interior volume reservoir.

17. The solution dispensing device of claim 10, whereby the solvent added to the refillable solution reservoir transfers through the refill cartridge about the aperture of the interior volume reservoir, the solution within the refill cartridge calibrated to mix with the solvent added to the refillable solution reservoir, dispensing the prescribed solution via the dispense port external of the device, upon actuation of the actuator mechanism.

18. The solution dispensing device of claim 10, whereby the refill cartridge is removable and of one or more materials selected from at least an organic material, cellulose, bonded cellulose, recycled or virgin plastic, polymer.

19. The solution dispensing device of claim 10, wherein the refill cartridge is configured to be used with, on or in the solution dispensing device.

20. The solution dispensing device of claim 10, having a means of dispensing increased solution and or air volume via the external dispense port of the solution dispensing device.

21. The solution dispensing device of claim 10, wherein at least one chamber comprises a plurality of chambers of measured concentrate solution cartridges, which combine and dispense when actuation of the actuator mechanism draws the solution independently whereby solutions mix, can combine with a volume of air and dispense via the external dispense port of the device.

22. The solution dispensing device of claim 10, the solute solution refill cartridge about the aperture of the lower section reservoir, the solute solution drawn from the cartridge incrementally upon actuation of the actuator mechanism, combined and mixed with a prescribed measured quantity of solvent from within the refillable solution reservoir drawn through and into at least one chamber of the actuator mechanism internal of the device, and dispense via the external dispense port.

23. The solution dispensing device of claim 10, wherein a solution cartridge refill is deposited about the aperture of the lower section and filled with a prescribed volume of solute solution, whereupon depositing the cartridge causes dissolvement all or in part, the solute solution is mixing with a material within the refillable solution reservoir into a prescribed concentrate solution mixture within the reservoir.

24. The solution refill cartridge of claim 23, the solute solution within the cartridge about the aperture of the lower section is released via the dissolvement of the cartridge in contact with the prescribed concentrate solution within the lower section reservoir, a means of peeling open, puncture, pierce, rupture a seal of the refill cartridge on, in, or within the interior volume reservoir, allowing the solute solution to combine with the concentrate solution within the reservoir, or any combination thereof.
